(19) United States
(12) Patent Application Publication
(10) Pub. No.: US 2015/0213242 A1
(43) Pub. Date: Jul. 30, 2015

(54) ELECTRONICS SECURITY APPLICATION

(71) Applicant: David Allen Taylor, Sterling Heights, MI (US)

(72) Inventor: David Allen Taylor, Sterling Heights, MI (US)

(21) Appl. No.: 14/604,813

(22) Filed: Jan. 26, 2015

Related U.S. Application Data
(60) Provisional application No. 61/931,216, filed on Jan. 24, 2014.

(51) Int. Cl. G06F 21/31; G06F 21/62

(52) U.S. Cl. CPC G06F 21/31; G06F 21/6218

(57) ABSTRACT

A method of restricting access on an electronic device by a first user restricting access of at least one electronic object to subsequent users of the electronic device. A method of restricting access on an electronic device by classifying an electronic object as private or public, entering a passcode to access the electronic device, and showing electronic objects based on the passcode entered. An application for restricting access on an electronic device, including a locking mechanism for locking out a portion of electronic objects on the electronic device and an accessing mechanism for unlocking and exposing user access to locked electronic objects.

### BACKGROUND OF THE INVENTION

1. Technical Field

The present invention relates to security programs for electronics and electronic programs. More specifically, the present invention relates to selective security programs that allow selective access to electronics and electronic programs.

2. Background Art

There are many people that own smart phones, tablets, computers, and various other electronic devices that have information of contacts that they do not want others to view. Most of these electronics are provided with some type of locking mechanism. This locking mechanism is many times invoked if the electronics are not used for a certain time period or a timed lockout. The electronic device then locks or restricts access to the device until some type of passcode or password is input to the device, thereby unlocking it. The device can then be used until the user closes/turns off the device or the device times out and locks again.

Some owners may wish to allow users access to their electronic devices. This requires the owner to supply the user with the password or passcode to the device where the user then would have access to the contents of the device. This can cause problems if there is proprietary information on the device or if for some reason the owner did not want to allow access to some of the information or applications on the device.

The owner may wish to keep some information from the user. This information could be material that is related to work, or necessary to keep from the user for many other reasons. Once the password or passcode is known, the user could then use the device when the owner perhaps does not want them to use it or for other nefarious purposes. It could also be that the user is a suspicious person and wishes to snoop on the owner's electronic device and would thus access the device without the permission of the owner of the device.

There remains a need for a method of an owner categorizing some things on an electronic device as “private” and still allow another user to access a “public” password or passcode whereby the user could get access to, for example, some of the information, applications, photos, SMS messages, text messages, files, etc. that are on the electronic device. There also remains a need for a method of selectively allowing access in a seamless manner such that the user is not aware that certain information has been labeled “private”.

### SUMMARY OF THE INVENTION

The present invention provides for a method of restricting access on an electronic device by a first user restricting access of at least one electronic object to subsequent users of the electronic device.

The present invention also provides for a method of restricting access on an electronic device by classifying an electronic object as private or public, entering a passcode to access the electronic device, and showing electronic objects based on the passcode entered.

The present invention further provides for an application for restricting access on an electronic device, including a locking mechanism for locking out a portion of electronic objects on the electronic device and an accessing mechanism for unlocking and exposing user access to locked electronic objects.

### DESCRIPTION OF THE DRAWINGS

Other advantages of the present invention are readily appreciated as the same becomes better understood by reference to the following detailed description when considered in connection with the accompanying drawings wherein:

FIG. 1 is a flowchart of the steps of setting up private and public electronic objects on the restrictive access app of the present invention; and

FIG. 2 is a flowchart of the steps of using the restrictive access app of the present invention.

### DETAILED DESCRIPTION OF THE INVENTION

The present invention generally provides for a restrictive access electronic application (“app”) or software program on computer readable media and methods that enable the owner of an electronic device to restrict access of electronic objects to other users of the electronic device. In other words, the present invention provides for a method of restricting access on an electronic device by a first user restricting access of at least one electronic object to subsequent users of the electronic device.

The term “application” as used herein refers to a computer software application, otherwise known as an “app”, that is stored on computer readable media, run, and operated on an electronic device, especially ones utilizing a touch screen. It should also be understood that the application can also be run on desktop computers that support applications or there can be a separate desktop interface accessible via a website that corresponds to the application.

“Electronic device” as used herein, refers to any type of device that is preferably compatible with “apps”, such as, but not limited to, phones, tablets, computers, digital music players, smart watches, wearable computers with optical head mounted displays, televisions, or any other suitable electronic device.

“Electronic object” as used herein, refers to any type of information, file, or program that the owner of an electronic device wants to restrict access to. The electronic object can be, but is not limited to, applications (especially social media applications TWITTER®, INSTAGRAM®, and FACEBOOK®, and credit card, debit card, or banking applications (such as GOGGLE WALLET™ or APPLE PAY™)), code, photos, emails, text messages, SMS messages, television channels, phone numbers, phone calls, contact lists, call logs, voicemail, videos, music, documents (especially any credit card or banking documents, or any other confidential information), programs, files, and portions thereof.

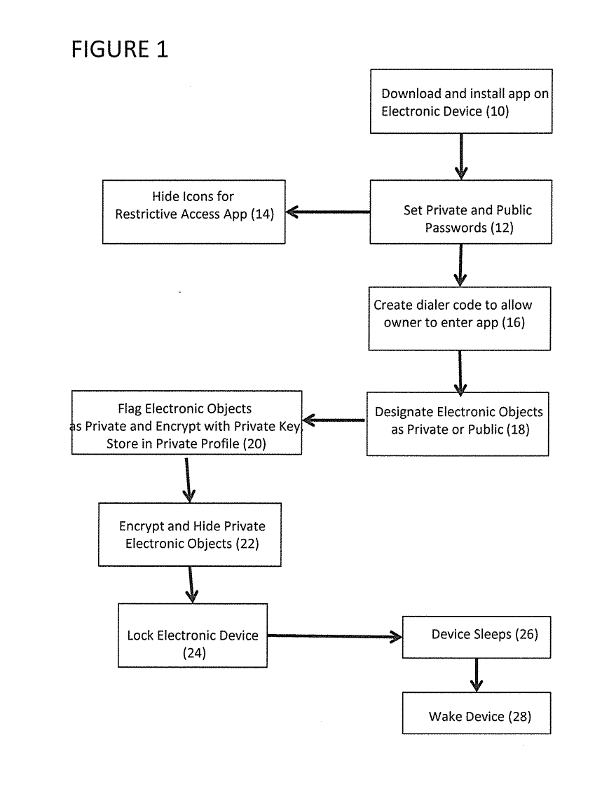

As shown in FIG. 1, the owner (i.e. a private user) downloads and installs (if necessary, installation can be automatic) the restrictive access app on their electronic device (10). The first time that the restrictive access app is used, a launcher icon can show up on the electronic device to launch the app. However, once the various codes described below have been set up, then only the owner can access the restrictive access app by typing a code and the app launches and opens. The restrictive access app itself can be hidden from view of the owner and other users (i.e. public users) (14) and only the owner has full access to it. Essentially, the app can operate in a “stealth” mode. Other users are therefore not aware of the app or that anything has been restricted on the electronic device and it looks like the electronic device is unlocked. The owner can access the app again in stealth mode, for example, by opening a “phone” or dialer app on the electronic device, the owner can type in a particular code on the screen, and the restrictive access app opens. A dialer code can be created that allows the owner to enter the app (16).

The restrictive access app can run inside any suitable operating system, such as, but not limited to, Android, iOS, Blackberry 10, Microsoft Phone, other mobile operating systems, Microsoft Windows, Mac OS, Linux, and other computer operating systems. The restrictive access app integrates directly with the electronic device settings for a seamless integration.

Once the app has been opened for the first time, the owner can set a private password/passcode (for use only by the owner) and a public password/passcode (for use by anyone else, or guests) (12). Alternatively, these passwords/passcodes can be predetermined and the app can indicate to the owner what these codes are. Multiple public password/passcodes can also be created for specific users to access specific electronic objects. Further use of the app can be restricted until the password/passcodes are set. The owner can also choose which operating system that the app will function in. The owner next categorizes or designates a particular electronic object, or a portion of the electronic object, as “private” or “public” (18) and that electronic object or portion thereof becomes flagged as “private” and becomes encrypted or becomes flagged as “public” (20, 22).

Electronic objects that the owner has categorized as “private” and “public” are accessible on the device with the use of a “private” password or passcode. Only the electronic objects that the owner has categorized as “public” are accessible on the device with the use of the “public” password or passcode. Therefore, the electronic objects categorized as “private” and data associated with that electronic object are safe from the view or access of other users. Essentially, the private electronic objects are hidden from view when the public password/passcode is used, but reappear when the private password/passcode is used. This categorization can further be seamless so that the user is not aware that certain electronic objects have been categorized as “private”. This helps avoid issues of breach of confidentiality while still allowing access to the device by users other than the owner.

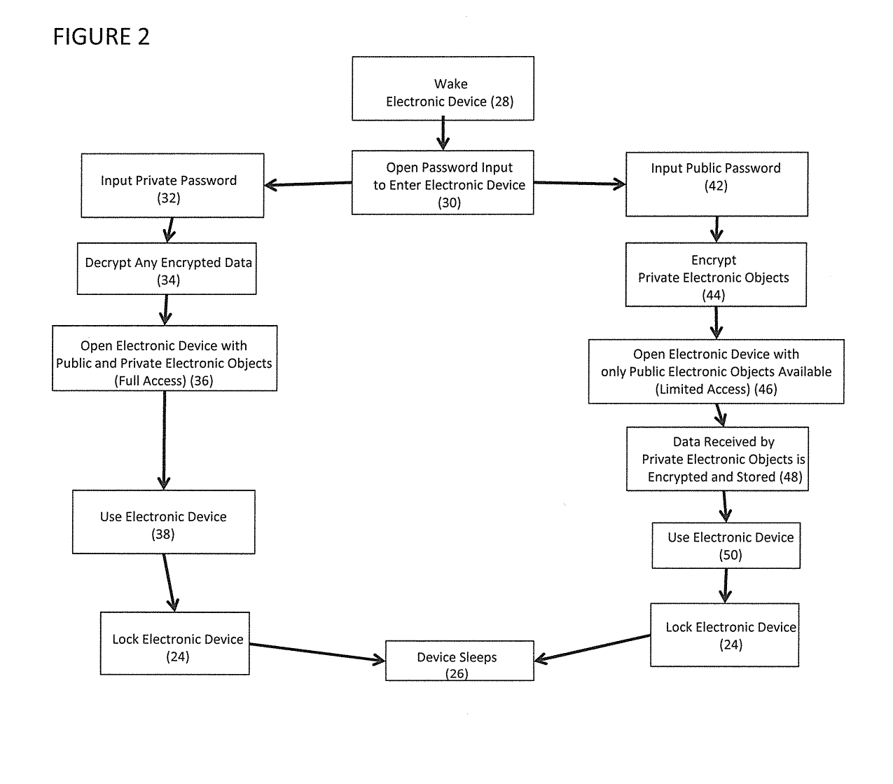

FIG. 2 shows several of the steps in the use of the electronic device. If the electronic device is asleep, first the owner or other user wakes the electronic device (28) and the password input is opened (30). When the owner enters their private password/passcode (32), they can access any private or public electronic object when the electronic device is used (38). When another user (i.e. other than the owner) enters the public password/passcode (42), only the public electronic objects can be accessed (46) when the electronic device is used (50). The passwords/passcodes can be entered on an unlock screen on the electronic device, and can work seamlessly with existing default lock programs on electronic devices (such as the lock screen on a smart phone). Alternatively, in stealth mode, access to public electronic objects can be a default mode, with no public password/passcode needed for a public user if an unlock screen is not used, but the restrictive access app must be opened to enter the private password/passcode or another mode of entering the private password/passcode must be used to access any private electronic objects. This gives the appearance that nothing has been restricted and that no passwords/passcodes are needed to use the electronic device. The owner can choose how the electronic device is unlocked within the app, and any other suitable method of unlocking the device can also be used (such as with the dialer described above).

The restrictive access app can also encrypts the private electronic objects (44) so that a user is not able to read or invoke the “hidden” or encrypted electronic objects. Any encryption/decryption within the restrictive access app can be done by methods known in the art.

If private electronic objects are received by the electronic device when the public password or passcode is invoked, then the private electronic objects are received and encrypted without any indication to the public user (48). Any encrypted electronic objects received in the public mode can be decrypted automatically and the owner can be notified of their receipt (such as by a visual alert or a sound alert) when the private password/passcode is next used by the owner (34). For example, any incoming phone calls from a private contact can be directed to voicemail without any notifications appearing on a phone when used by a public user, and then when the private password/passcode is used, a notification can appear for the new voicemail to the owner. Also, for example, any new messages, tweets, or instagrams, do not appear in the public mode but only once the private password/passcode is used. All encryption/decryption of electronic objects can be stored in the electronic device's database or other storage mechanisms (i.e. computer readable media) while a public user is using the electronic device.

When the owner or user is done using the electronic device, they can logoff or lock the device (24) and the device sleeps (26). Upon waking the device (28), the appropriate password/passcode can be entered and the method of use can be performed again according to whether the owner or user is using the electronic device.

In a particular embodiment, the restrictive access app can classify electronic objects as private on a television or smart television in order to lock them from other users. These electronic objects can be particular channels, particular apps, and especially pay per use channels or apps and mature programming channels and apps that the owner does not want other users (i.e. children, guests) to have access to. The restrictive access app can use the stealth mode so that other users are not aware there are other existing apps or channels in the private mode. The smart television can run on apps for particular stations or pay for packages, and access to particular apps can be restricted by performing the above described method.

In another particular embodiment, the restrictive access app can classify certain electronic objects as private in an office computer network. For example, the electronic objects can be proprietary applications that a company does not want all of its workers to have access to. Other applications that the workers are allowed to use can be classified as public using the above described method.

The present invention generally provides for a method of restricting access on an electronic device, by classifying an electronic object as private or public, entering a passcode to access the electronic device, and showing electronic objects based on the passcode entered. Each of these steps have been described above.

The present invention also provides for an application for restricting access on an electronic device, including a locking mechanism for locking out a portion of electronic objects on the electronic device and an accessing mechanism for unlocking and exposing user access to the locked electronic objects. The locking mechanism includes a password mechanism that allows the owner to set the private and public passwords, and the locking mechanism allows the owner to designate which electronic objects or portions of electronic objects are private or public and therefore able to be viewed by a private or public user as described above. The accessing mechanism can include the dialer or phone function as described above that the owner can use to type in their private password in order to access the private electronic objects. An encryption and decryption mechanism is included for encrypting private electronic objects received while the application is operated with a public password and decrypting private electronic objects the next time a private password is entered, as described above. The application can further include a stealth mechanism for operating the application without the knowledge of a public user. The stealth mode has been described above. A relocking mechanism can be included for relocking the electronic device after use, i.e. after a private user has used the electronic device, the electronic device can be locked such that a public user cannot access the private electronic objects (or any electronic objects at all until the public password has been entered). The application can include any mechanisms necessary for performing the method described above. The application is preferably stored on computer readable media.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A method of restricting access on an electronic device, including the step of:
a first user restricting access of at least one electronic object to subsequent users of the electronic device.

2. The method of claim 1, wherein the electronic device is chosen from the group consisting of phones, tablets, computers, digital music players, smart watches, wearable computers with optical head mounted displays, and televisions.

3. The method of claim 1, wherein the electronic object is chosen from the group consisting of applications, code, photos, emails, text messages, SMS messages, television channels, phone numbers, phone calls, contact lists, call logs, voicemail, videos, music, documents, programs, files, portions thereof, and combinations thereof.

4. A method of restricting access on an electronic device, including the steps of:
classifying an electronic object as private or public;
entering a passcode to access the electronic device; and
showing electronic objects based on the passcode entered.

5. The method of claim 4, wherein the electronic device is chosen from the group consisting of phones, tablets, computers, digital music players, smart watches, wearable computers with optical head mounted displays, and televisions.

6. The method of claim 4, wherein the electronic object is chosen from the group consisting of applications, code, photos, emails, text messages, SMS messages, television channels, phone numbers, phone calls, contact lists, call logs, voicemail, videos, music, documents, programs, files, portions thereof, and combinations thereof.

7. The method of claim 4, further including, before said classifying step, the step of setting at least one private passcode and at least one public passcode.

8. The method of claim 7, wherein when the private passcode is entered, said showing step is further defined as showing private electronic objects and public electronic objects.

9. The method of claim 7, wherein when the public passcode is entered, said showing step is further defined as showing only public electronic objects.

10. The method of claim 9, further including the step of receiving and encrypting private objects received by the electronic device without any indication to a public user.

11. The method of claim 10, further including the step of storing the encrypted private objects on computer readable media in the electronic device.

12. The method of claim 10, further including the step of automatically decrypting encrypted private objects when a private passcode next is entered on the electronic device.

13. The method of claim 12, further including the step of notifying a private user of receipt of the private objects.

14. The method of claim 4, wherein said classifying step further includes the step of encrypting electronic objects classified as private.

15. The method of claim 4, wherein said entering step is further defined as entering a passcode on an unlock screen.

16. The method of claim 4, wherein said entering step is performed only for showing private electronic objects and public electronic objects are shown as a default mode.

17. The method of claim 4, wherein said method is performed with an application that is hidden from view in a stealth mode.

18. The method of claim 17, further including the step of accessing the application by typing a code in a phone application.

19. The method of claim 4, further including the steps of logging off the electronic device, and repeating said entering and showing steps.

20. An application for restricting access on an electronic device, comprising locking means for locking out a portion of electronic objects on said electronic device and accessing means for unlocking and exposing user access to locked electronic objects.

21. The application of claim 20, wherein said locking means includes password means for an owner setting private and public passwords, and designating means for designating which portion of electronic objects are private or public.

22. The application of claim 20, wherein said accessing means is further defined as a dialer function.

23. The application of claim 20, further including encryption and decryption means for encrypting private electronic objects received while said application is operated with a public password and decrypting private electronic objects the next time a private password is entered.

24. The application of claim 20, further including stealth means for operating said application without the knowledge of a public user.

25. The application of claim 20, further including relocking means for relocking said electronic device after use.
